(19) United States
(12) Patent Application Publication
(10) Pub. No.: US 2026/0290246 A1
(43) Pub. Date: Sep. 24, 2026

(54) DISPLAY DEVICE AND CONTROL METHOD THEREOF

(71) Applicant: SAMSUNG ELECTRONICS CO., LTD., Suwon-si (KR)

(72) Inventor: Sungjin LIM, Suwon-si (KR)

(73) Assignee: SAMSUNG ELECTRONICS CO., LTD., Suwon-si (KR)

(21) Appl. No.: 19/682,859

(22) Filed: May 20, 2026

Related U.S. Application Data
(63) Continuation of application No. PCT/KR2024/014046, filed on Sep. 13, 2024.

(30) Foreign Application Priority Data
Dec. 20, 2023 (KR) 10-2023-0187763

(51) Int. Cl. G09G 3/3241; G01K 3/00; G09G 3/00

(52) U.S. Cl. CPC G09G 3/3241; G01K 3/005; G09G 3/007; G09G 2300/0842; G09G 2320/0257; G09G 2320/041; G09G 2320/048; G09G 2320/0606; G09G 2320/0613; G09G 2320/0626; G09G 2354/00

(57) ABSTRACT

A display apparatus includes: a display panel comprising a plurality of pixels, a temperature detector configured to detect a temperature of each pixel of the plurality of pixels, and at least one panel processor configured to adjust a luminance of the display panel based on the temperature of each pixel, a reference temperature, and a luminance adjustment value, wherein the at least one panel processor is configured to determine the reference temperature and the luminance adjustment value based on at least one of a panel protection menu, an afterimage index, and a cumulative viewing time,

### CROSS-REFERENCE TO RELATED APPLICATIONS

This application is a continuation of International Application No. PCT/KR2024/014046, filed on Sep. 13, 2024, which is based on and claims priority to Korean Patent Application No. 10-2023-0187763, filed on Dec. 20, 2023, in the Korean Intellectual Property Office, the disclosures of which are incorporated by reference herein in their entireties.

### BACKGROUND

### 1. Field

The present disclosure relates to a display apparatus for preventing occurrence of afterimages and a control method thereof.

### 2. Description of Related Art

A liquid crystal display (LCD), an organic light-emitting diode (OLED)-based display apparatus, a mini-LED-based display apparatus, and a micro-LED-based display apparatus are widely used.

The OLED-based display apparatus (hereinafter referred to as an OLED display apparatus) includes an OLED element that emits light through an organic light emitting layer by recombination of electrons and holes.

The OLED display apparatus has a difficulty in which afterimages occur in an area, on which a logo is displayed, on a display panel screen due to deterioration of the OLED element caused by increased current stress during a long-term operation. In addition, the afterimages have a difficulty that a picture quality of the OLED display apparatus has deteriorated.

### SUMMARY

Provided are a display apparatus that may determine a reference temperature and a luminance adjustment value based on at least one of a panel protection menu, a cumulative viewing time, an afterimage index, and an external temperature, and adjust a luminance of a display panel based on the determined reference temperature and luminance adjustment value, and temperatures of a plurality of pixels of the display panel, and a control method thereof.

Further, provided are a display apparatus that may a luminance of a portion or all of a display panel based on temperatures of a plurality of pixels of the display panel and a reference temperature, and a control method thereof.

According to an aspect of the disclosure, a display apparatus includes: a display panel comprising a plurality of pixels; a temperature detector configured to detect a temperature of each pixel of the plurality of pixels; and at least one panel processor configured to adjust a luminance of the display panel based on the temperature of each pixel of the plurality of pixels, a reference temperature, and a luminance adjustment value, wherein the at least one panel processor is configured to determine the reference temperature and the luminance adjustment value based on at least one of a panel protection menu, an afterimage index, and a cumulative viewing time.

The panel protection menu may comprise: a logo brightness menu for setting a brightness of a logo, and a pixel shift menu for setting whether to perform pixel shift, and the at least one panel processor may be configured to determine at least one of the reference temperature and the luminance adjustment value based on brightness information of the logo set by the logo brightness menu, and determine at least one of the reference temperature and the luminance adjustment value based on whether to perform the pixel shift set by the pixel shift menu.

The display apparatus may further include a temperature sensor configured to detect an external temperature outside the display panel, and the at least one panel processor may be further configured to determine the reference temperature and the luminance adjustment value based on the external temperature.

The reference temperature and the cumulative viewing time may have an inverse relationship in which the reference temperature decreases as the cumulative viewing time increases, and the luminance adjustment value and the cumulative viewing time may have a direct relationship in which the luminance adjustment value increases as the cumulative viewing time increases.

The reference temperature and the afterimage index may have an inverse relationship in which the reference temperature decreases as the afterimage index decreases, and the luminance adjustment value and the afterimage index may have a direct relationship in which the luminance adjustment value increases as the afterimage index increases.

The at least one panel processor may be configured to obtain a highest temperature among the temperature of each pixel of the plurality of pixels, and based on the highest temperature being greater than or equal to the reference temperature, adjust the luminance of each pixel of the plurality of pixels of the display panel based on the luminance adjustment value.

The at least one panel processor may be configured to obtain a highest temperature among the temperature of each of the plurality of pixels, obtain at least one pixel having a temperature greater than or equal to the reference temperature among the plurality of pixels based on the highest temperature being greater than or equal to the reference temperature, and adjust the luminance of the at least one pixel based on the luminance adjustment value.

The display apparatus may further include an input interface configured to receive information on the panel protection menu and transmit the information on the panel protection menu to the at least one panel processor.

The display apparatus may further include a display driver connected to the display panel, and the at least one panel processor may be configured to convert an image signal received from an external device into a control signal of each pixel of the plurality of pixels and transmit the control signal of each pixel of the plurality of pixels to the display driver, and detect the temperature of each pixel of the plurality of pixels based on an operation signal of the display driver.

The at least one panel processor may comprise: at least one first processor configured to receive the image signal from the external device, and at least one second processor configured to convert the image signal received from the at least one first processor into the control signal of each pixel of the plurality of pixels, transmit the control signal of each pixel of the plurality of pixels to the display driver, detect the temperature of each of the plurality of pixels, and adjust the luminance of the display panel. The at least one first processor may be further configured to the at least one first processor is further configured to obtain at least one of the panel protection menu, the cumulative viewing time, and the afterimage index, and transmit the at least one of the panel protection menu, the cumulative viewing time, and the afterimage index to the at least one second processor.

According to an aspect of the disclosure, a control method of a display apparatus includes: determining a reference temperature and a luminance adjustment value based on at least one of a panel protection menu, an afterimage index, and a cumulative viewing time; detecting a temperature of each pixel of a plurality of pixels of a display panel; and adjusting a luminance of the display panel based on the temperature of each pixel of the plurality of pixels, the reference temperature, and the luminance adjustment value.

The determining the reference temperature and the luminance adjustment value based on the at least one of the panel protection menu, the afterimage index, and the cumulative viewing time may comprise: determining at least one of the reference temperature and the luminance adjustment value based on brightness information of a logo set by a logo brightness menu in the panel protection menu, and determining at least one of the reference temperature and the luminance adjustment value based on whether to perform pixel shift set by a pixel shift menu in the panel protection menu.

The control method may further include: detecting an external temperature outside the display panel; and determining the reference temperature and the luminance adjustment value based on the external temperature.

The reference temperature and the cumulative viewing time may have an inverse relationship in which the reference temperature decreases as the cumulative viewing time increases, and the luminance adjustment value and the cumulative viewing time may have a direct relationship in which the luminance adjustment value increases as the cumulative viewing time increases.

The reference temperature and the afterimage index may have an inverse relationship in which the reference temperature decreases as the afterimage index decreases, and the luminance adjustment value and the afterimage index may have a direct relationship in which the luminance adjustment value increases as the afterimage index increases.

Detecting the temperature of each pixel of the plurality of pixels of the display panel may comprise: obtaining an operation signal of each pixel; detecting the temperature of each pixel of the plurality of pixels based on the operation signal of each pixel; and obtaining a highest temperature among the temperature of each pixel of the plurality of pixels. Adjusting the luminance of the display panel may comprise: based on the highest temperature being greater than or equal to the reference temperature, adjusting the luminance of each pixel of the plurality of pixels of the display panel based on the luminance adjustment value.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view of a display apparatus according to one or more embodiments;

FIG. 2 is an example diagram of a display panel provided in the display apparatus according to one or more embodiments;

FIG. 3 is an example diagram of an organic light-emitting element provided in the display apparatus according to one or more embodiments.

FIG. 4 is a control configuration diagram of the display apparatus according to one or more embodiments;

FIG. 5 is a detailed configuration diagram of a panel processor and a display driver of the display apparatus according to one or more embodiments;

FIG. 6 is an example diagram of a pixel driving circuit provided in the display apparatus according to one or more embodiments;

FIG. 7 is an example diagram of a panel protection menu of the display apparatus according to one or more embodiments;

FIG. 8 is an example diagram of a reference temperature and a luminance reduction rate corresponding to a log brightness menu of the display apparatus according to one or more embodiments;

FIG. 9 is an example diagram of a reference temperature and a luminance reduction rate corresponding to a pixel shift menu of the display apparatus according to one or more embodiments;

FIG. 10 is an example diagram of a reference temperature and a luminance reduction rate corresponding to a cumulative viewing time of the display apparatus according to one or more embodiments;

FIGS. 11 and 12 are example diagrams illustrating a state in which the display apparatus according to one or more embodiments displays an image;

FIG. 13 is a graph illustrating a luminance over time of the display apparatus according to one or more embodiments;

FIG. 14 is a graph illustrating a temperature of a pixel over time of the display apparatus according to one or more embodiments;

FIG. 15 is a control flowchart for determining a reference temperature and luminance adjustment value of the display apparatus according to one or more embodiments; and

FIG. 16 is a control flowchart for adjusting the luminance of the display apparatus according to one or more embodiments.

### DETAILED DESCRIPTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items. For example, the expression, “at least one of A, B, and C,” should be understood as including only A, only B, only C, both A and B, both A and C, both B and C, or all of A, B, and C.

Herein, the expressions “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

The term of “and/or” includes a plurality of combinations of relevant items or any one item among a plurality of relevant items.

Hereinafter example embodiments of the present disclosure will be described in detail with reference to the accompanying drawings.

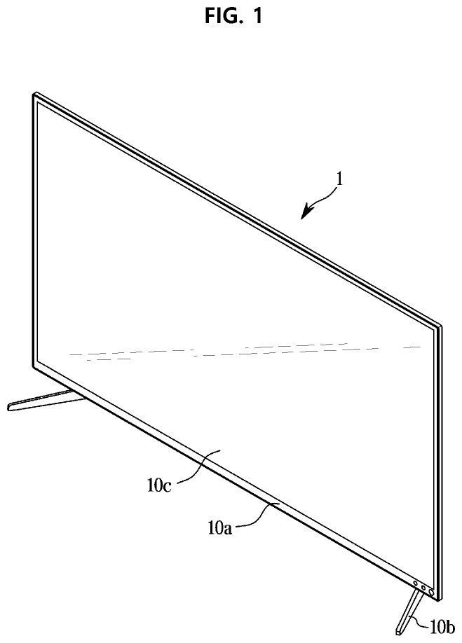

FIG. 1 is a view of a display apparatus according to one or more embodiments.

A display apparatus 1 is a device configured to displays visual and three-dimensional image information, such as a display portion of a mobile device such as a laptop, a smart phone, and a tablet, a monitor of a personal computer (PC), a television, a display portion of a home appliance, and a display portion in a vehicle.

In the embodiment, a television among the display apparatuses 1 will be described.

As illustrated in FIG. 1, the display apparatus 1 includes a main body 10a forming an exterior and a stand 10b mounted on a lower portion of the main body 10a. The display apparatus 1 may also be installed on a wall using a bracket without a stand.

The display apparatus 1 may include a display panel 10c provided in the main body 10a and configured to display an image.

The main body 10a may include a cover covering a rear surface of the display panel 10c.

The main body 10a may further include a bezel covering an edge of the display panel 10c. In this case, the cover and the bezel of the main body may be detachably coupled to each other.

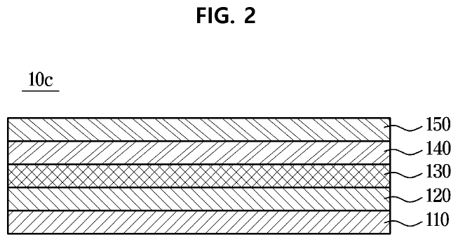

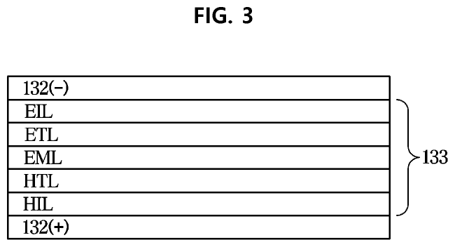

FIG. 2 is an example diagram of a display panel provided in the display apparatus according to one or more embodiments, which will be described with reference to FIG. 3. FIG. 3 is an example diagram of an organic light-emitting element provided in the display apparatus according to one or more embodiments.

Among the display apparatuses, a display panel of an organic light-emitting diode (OLED)-based display apparatus will be described.

As illustrated in FIG. 2, the display panel 10c of the display apparatus 1 may include a base substrate 110, a driving substrate 120, an organic light-emitting substrate 130, an encapsulating substrate 140, and a polarizing plate 150.

The base substrate 110 may be a transparent insulating substrate formed of glass, quartz, and ceramic. The base substrate 110 may be a transparent flexible substrate formed of plastic.

The driving substrate 120 may be provided on the base substrate 110.

The driving substrate 120 may be electrically and physically connected to the organic light-emitting substrate 130.

The driving substrate 120 may include a thin film transistor (TFT) circuit board configured to transmit a control signal for driving a plurality of organic light-emitting elements provided on the organic light-emitting substrate 130. The TFT circuit board may include a plurality of transistors and a plurality of capacitors.

The organic light-emitting substrate 130 may display an image by emitting light according to a control signal received from the driving substrate 120. The light generated from the organic light-emitting substrate 130 may be emitted to an outside through the encapsulating substrate 140.

As illustrated in FIG. 3, the organic light-emitting substrate 130 may include a first electrode 131, a second electrode 132, and a plurality of organic light-emitting elements 133.

The first electrode 131 and the second electrode 132 include at least one of a transparent conductive material and a semi-transparent metal.

The transparent conductive material includes at least one of Indium Tin Oxide (ITO), Indium Zinc Oxide (IZO), Zinc Oxide (ZnO), and In2O3 (Indium Oxide).

The semi-transparent metal may be a metal formed of one or more of magnesium (Mg), silver (Ag), gold (Au), calcium (Ca), lithium (Li), chromium (Cr), and aluminum (Al), or an alloy thereof.

The first electrode 131 may be an anode electrode, which is a hole injection electrode, and the second electrode 132 may be a cathode electrode, which is an electron injection electrode.

Each organic light-emitting element 133 may include at least one of an emitting layer (EML), a hole-injection layer (HIL), a hole-transporting layer (HTL), an electron-transporting layer (ETL), and an electron-injection layer (EIL).

Among the aforementioned layers, the remaining layers except the emitting layer may be omitted as needed.

When each organic light-emitting element 133 includes all of the layers described above, the hole-injection layer (HIL) may be disposed on the first electrode 131, and the hole-transporting layer (HTL), the emitting layer (EML), the electron-transporting layer (ETL), and the electron-injection layer (EIL) may be sequentially stacked thereon.

The emitting layer (EML) may include an organic material. Various organic materials may be used, including copper phthalocyanine (CuPc), N,N-di(naphthalene-1-yl)-N,N′-diphenyl-benzidine (NPB), and tris-8-hydroxyquinoline aluminum (Alq3).

The organic light-emitting substrate 130 may further include a polarizing film provided on the second electrode 132 and having a polarizing axis. The polarizing film may transmit light that is aligned with the polarizing axis and reflect light that is not aligned with the polarizing axis. Accordingly, light passing through the polarizing film may be linearly polarized in a direction of the polarizing axis of the polarizing film.

The encapsulating substrate 140 seals the organic light-emitting substrate 130 and the driving substrate 120.

The encapsulating substrate 140 may be formed of a glass substrate, a substrate formed of various plastic materials such as acrylic, or a metal plate.

The polarizing plate 150 may be provided on the encapsulating substrate 140. The polarizing plate 150 serves to block external light reflection.

A polarizing axis of the polarizing plate 150 may be the same as the polarizing axis of the polarizing film of the organic light-emitting substrate 130.

The polarizing plate 150 may also be provided between the encapsulating substrate 140 and the organic light-emitting substrate 130.

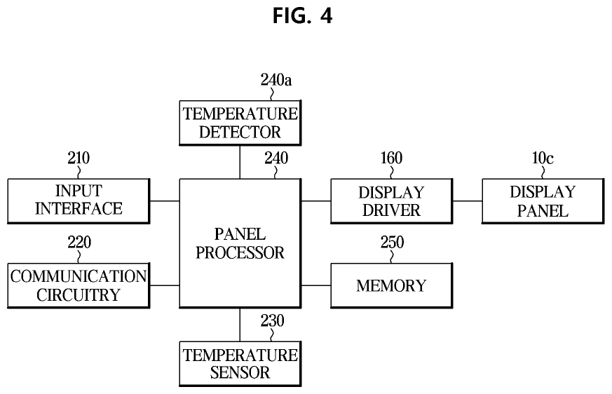

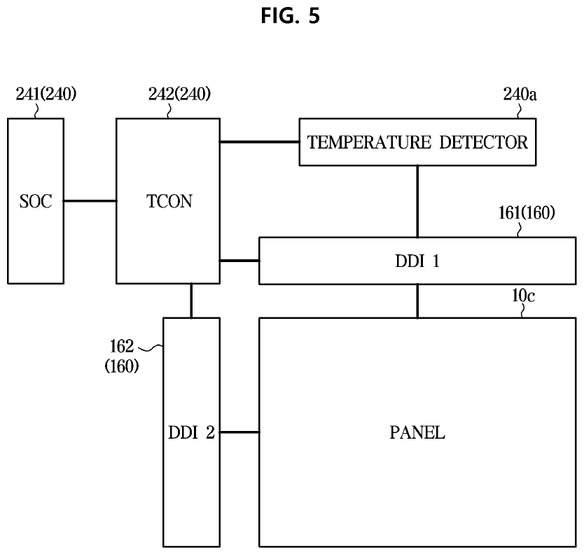

FIG. 4 is a control configuration diagram of the display apparatus according to one or more embodiments, which will be described with reference to FIGS. 5 to 14.

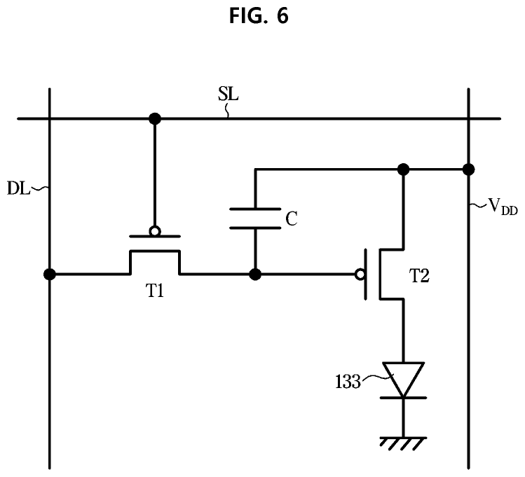

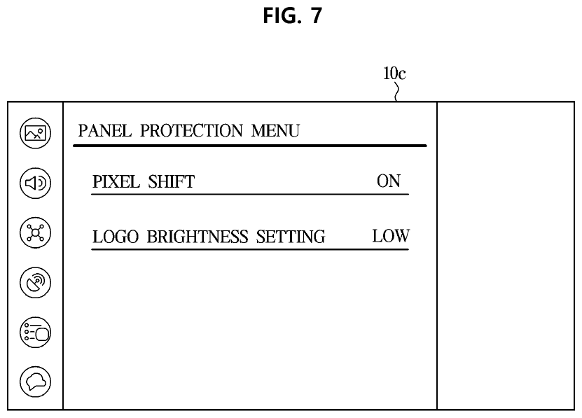

FIG. 5 is a detailed configuration diagram of a panel processor and a display driver of the display apparatus according to one or more embodiments, FIG. 6 is an example diagram of a pixel driving circuit provided in the display apparatus according to one or more embodiments, and FIG. 7 is an example diagram of a panel protection menu of the display apparatus according to one or more embodiments.

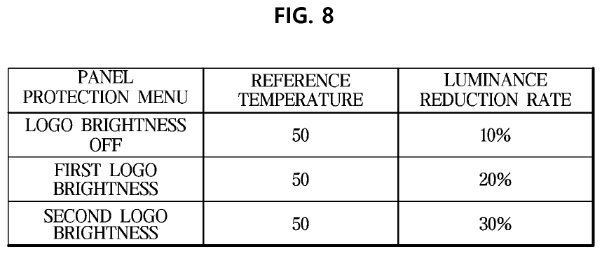

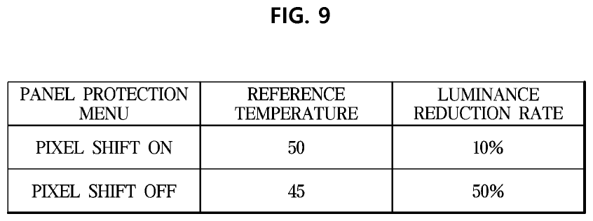

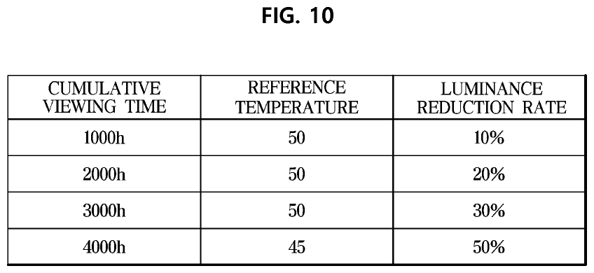

FIG. 8 is an example diagram of a reference temperature and a luminance reduction rate corresponding to a log brightness menu of the display apparatus according to one or more embodiments, FIG. 9 is an example diagram of a reference temperature and a luminance reduction rate corresponding to a pixel shift menu of the display apparatus according to one or more embodiments, and FIG. 10 is an example diagram of a reference temperature and a luminance reduction rate corresponding to a cumulative viewing time of the display apparatus according to one or more embodiments.

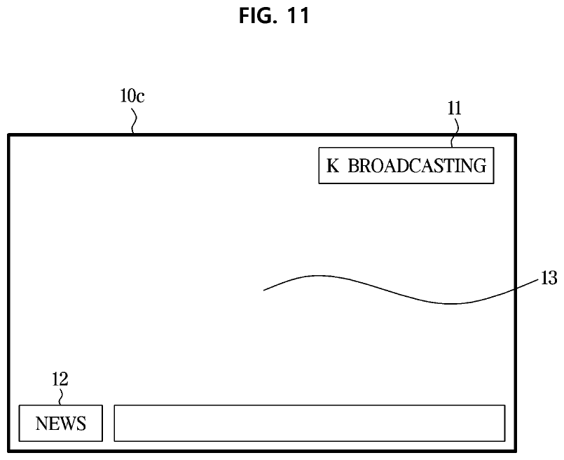

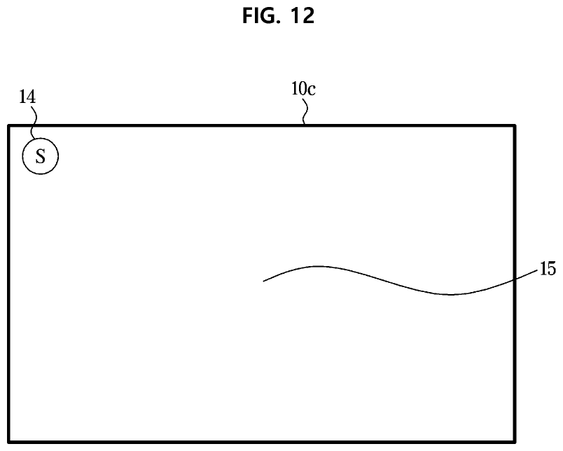

FIGS. 11 and 12 are example diagrams illustrating a state in which the display apparatus according to one or more embodiments displays an image.

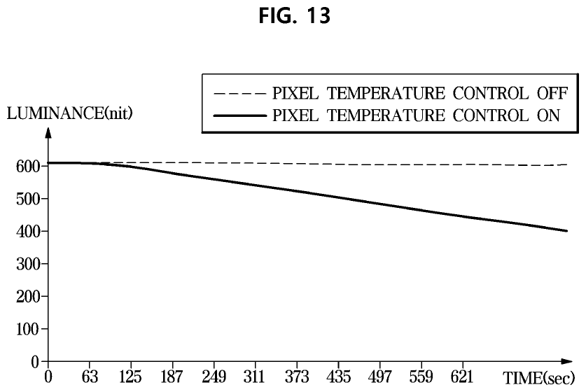

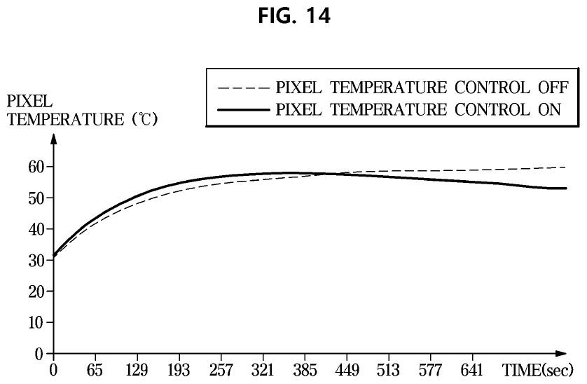

FIG. 13 is a graph illustrating a luminance over time of the display apparatus according to one or more embodiments, and FIG. 14 is a graph illustrating a temperature of a pixel over time of the display apparatus according to one or more embodiments.

The display apparatus 1 may include the display panel 10c, a display driver 160, an input interface 210, a communication circuitry 220, a temperature sensor 230, a panel processor 240, and a memory 250.

The structure of the display panel 10c is described with reference to FIGS. 2 and 3, and thus it will be omitted.

The display panel 10c may include a plurality of pixels.

Each pixel may include a first sub-pixel, a second sub-pixel, and a third sub-pixel. The first sub-pixel may correspond to a first organic light-emitting element configured to emit red light, the second sub-pixel may correspond to a second organic light-emitting element configured to emit green light, and the third sub-pixel may correspond to a third organic light-emitting element configured to emit blue light.

The display panel 10c may include a plurality of pixel driving circuits 121 corresponding to each of the organic light-emitting elements 133. The plurality of pixel driving circuits 121 may be provided on the driving substrate 120.

As illustrated in FIG. 6, each pixel driving circuit 121 may include a first transistor T1, a second transistor T2, and a capacitor C.

A gate terminal of the first transistor T1 may be connected to a scan line SL, and a drain terminal of the first transistor T1 may be connected to a data line DL.

A source terminal of the first transistor T1 may be connected to a gate terminal of the second transistor T2.

The capacitor C may be provided between the gate terminal and a drain terminal of the second transistor T2. The organic light-emitting element 133 may be connected to a source terminal of the second transistor T2.

The drain terminal of the second transistor T2 may be connected to a power line VDD.

The data line DL may be a line supplied with main power.

The scan line SL is a gate line that supplies a current to the second transistor T2.

Electrons may be stored in a capacitor supplied with a current by the second transistor T2.

A current may flow to the organic light-emitting element 133 as the second transistor T2 is turned on.

The scan line may be arranged to intersect with the data line. In this case, an intersection point of the scan line and the data line may correspond to a sub-pixel.

A current flowing in the organic light-emitting element 133 means a current flowing in the sub-pixel.

Each sub-pixel may emit light with a brightness corresponding to an amount of current flowing through the sub-pixel.

The pixel driving circuit is not limited to the pixel driving circuit illustrated in FIG. 6. That is, in addition to the pixel driving circuit structure illustrated in FIG. 6, it is also possible to implement a circuit with a structure of a different structure.

The display driver 160 (Display Driver IC (DDI)) may be connected to the display panel 10c.

The display driver 160 may receive a control signal for displaying an image from the panel processor 240 and transmit the received control signal to the display panel 10c.

The control signal for displaying the image may include a scan signal and a data signal.

The display driver 160 may include a first driver 161 and a second driver 162.

The first driver 161 may include a data line DL. The first driver 161 may be connected to the driving substrate 120 of the display panel 10c via the data line DL. The data line DL of the first driver 161 may be connected to the drain terminal of the first transistor T1 of the pixel driving circuit 121.

The first driver 161 may transmit a data signal to the driving substrate 120 of the display panel 10c via the data line DL, and may transmit the data signal to the plurality of pixel driving circuits of the driving substrate.

The data signal may be a signal that creates a difference in the color that is to be expressed by the sub-pixels.

The first driver 161 may include a first display driver integrated circuit (Display Driver IC (DDI)).

The first display driver integrated circuit is also referred to as a source driver integrated circuit.

The second driver 162 may include a scan line SL. The second driver 162 may be connected to the driving substrate 120 of the display panel 10c via the scan line SL.

The scan line SL of the second driver 162 may be connected to the gate terminal of the first transistor T1 of the pixel driving circuit 121.

The second driver 162 may transmit a scan signal to the driving substrate 120 of the display panel 10c via the scan line SL, and may transmit the scan signal to the plurality of pixel driving circuits of the driving substrate.

The second driver 162 may include a second display driver integrated circuit (Display Driver IC (DDI)).

The second display driver integrated circuit is also referred to as a gate driver integrated circuit.

The input interface 210 may receive user input.

The user input may include selection information of an external device, selection information of content, and setting information of a panel protection menu.

Particularly, the input interface 210 may receive selection information of an external device for communication connection with the display apparatus 1.

The external device may include a set-top box, a user device, and a removable storage device (for example, USB memory, and external hard drive).

The user device may be carried by a user or placed in the user's home or office. The user device 2 may include a personal computer, a terminal, a portable telephone, a smart phone, a handheld device, and a wearable device, but is not limited thereto.

The input interface 210 may receive selection information of at least one content among a plurality of contents.

The plurality of contents may include a plurality of contents received via a set-top box, a plurality of contents received via a user device, and a plurality of contents received via a removable storage device.

The input interface 210 may include setting information for the panel protection menu.

As illustrated in FIG. 7, the panel protection menu may include a logo brightness menu and a pixel shift menu.

A logo may be an image displayed on a display panel for a predetermined time in a specific location. For example, a logo may include a broadcaster logo, an age rating logo, or a banner.

The logo brightness menu is a menu for setting whether to set a brightness of a logo and for setting a brightness of a logo.

For example, the logo brightness menu may include a logo brightness setting off, which maintains the brightness of the logo, a first logo brightness, which sets the brightness of the logo to a first brightness, and a second logo brightness, which sets the brightness of the logo to a second brightness. The first brightness is a lower brightness than the second brightness.

For example, in the logo brightness menu of the display panel, the first logo brightness may be displayed as ‘Low’, and the second logo brightness may be displayed as ‘High’.

The pixel shift menu is a menu for setting whether to shift pixels in which the logo is displayed.

For example, the pixel shift menu may include a pixel shift on and a pixel shift off.

The pixel shift menu is a function that displays images by moving pixels at regular intervals when the pixel shift menu is set to the pixel shift on.

The input interface 210 may include a tact switch, a push switch, a slide switch, a toggle switch, a micro switch, a touch switch, a touch pad, a touch screen, a jog dial, and/or a microphone.

The input interface 210 may include a remote controller.

The communication circuitry 220 may communicate with an external device. The communication circuitry 220 may transmit image information, which is received from the external device in communication therewith, to the panel processor 240.

The communication circuitry 220 may also receive a temperature outside the display apparatus from a temperature sensor provided outside the display apparatus, and transmit the received external temperature to the panel processor 240.

The communication circuitry 220 may include at least one of a short-range communication module or a long-range communication module.

The communication circuitry 220 may transmit data to an external device or receive data from an external device. For example, the communication circuitry 220 may establish communication with an external device and transmit and receive various types of data.

For this, the communication circuitry 220 may support the establishment of a direct (for example. wired) communication channel or wireless communication channel between external devices, and the performance of communication through the established communication channel.

According to one or more embodiments, the communication circuitry 220 may include a wireless communication module (for example, a cellular communication module, a short-range wireless communication module, or a global navigation satellite system (GNSS) communication module) or a wired communication module (for example, a local area network (LAN) communication module, or a power line communication module).

The communication circuitry 220 may communicate with external devices via a first network (for example, a short-range communication network such as Bluetooth, wireless fidelity (Wi-Fi) direct, or infrared data association (IrDA)) or a second network (for example, a long-range communication network such as a legacy cellular network, a 5G network, a next-generation communication network, the Internet, or a computer network (for example, a LAN or WAN)). These various types of communication modules may be integrated into a single component (for example, a single chip) or implemented as a plurality of separate components (for example, a plurality chips).

The short-range wireless communication module may include a Bluetooth communication module, a Bluetooth Low Energy (BLE) communication module, a near field communication module, a WLAN (Wi-Fi) communication module, a Zigbee communication module, an infrared Data Association (IrDA) communication module, a Wi-Fi Direct (WFD) communication module, an ultrawideband (UWB) communication module, an Ant+ communication module, or a microwave (uWave) communication module, but is not limited thereto.

The display apparatus 1 may also include the temperature sensor 230 configured to detect an external temperature. In this case, the temperature sensor 230 may be provided in the main body 10a. The temperature sensor 230 provided in the main body 10a may transmit the detected temperature to the panel processor 240.

The panel processor 240 may control the overall operation of the display apparatus.

The panel processor 240 converts an image signal received from an external device into a control signal of each pixel and transmits the control signal of each pixel to the display driver 160.

The control signal of each pixel may include a voltage signal of each pixel.

The panel processor 240 detects a temperature of each pixel of the display panel 10c based on an operation signal of each of the plurality of pixels, and adjusts the luminance of the display panel based on the detected temperature of each pixel and a reference temperature.

The panel processor 240 may include a temperature detector 240a configured to detect a temperature of each pixel of the display panel 10c.

That is, the panel processor 240 may include a temperature detector configured to detect a temperature of each pixel of the display panel 10c based on the operation signal of each of the plurality of pixels.

The temperature detector 240a may also be provided separately from the panel processor 240. In this case, the temperature detector 240a may transmit information on the detected temperature of each pixel to the panel processor 240.

The operation signal of each of the plurality of pixels may include a current signal of each of the plurality of pixels.

The operation signal of each of the plurality of pixels may include a voltage signal of each of the plurality of pixels.

The operation signal of each of the plurality of pixels may include a data signal of each of the plurality of pixels.

The panel processor 240 may receive the data signal of each pixel from the first driver 161 and detect the current signal of each pixel based on the received data signal of each pixel.

The current signal corresponding to each of data signal may be pre-stored in a table.

The panel processor 240 may receive a data signal of each pixel from the first driver 161 during a blank period, and detect a current signal of each pixel based on the received data signal of each pixel.

The blank period may be a period between two frames where a black screen is displayed.

When the panel processor 240 adjusts the luminance of the plurality of pixels, the panel processor 240 may obtain a highest temperature among the detected temperature of each pixel, and adjust the luminance of the plurality of pixels of the display panel based on the obtained highest temperature being greater than or equal to the reference temperature.

When the panel processor 240 adjusts the luminance of the plurality of pixels, the panel processor 240 may obtain a highest temperature among the detected temperature of each pixel, and based on the obtained highest temperature being greater than or equal to the reference temperature, obtain at least one pixel, which has a temperature greater than or equal to the reference temperature, among the plurality of pixels, and adjust a luminance of the obtained at least one pixel.

When the panel processor 240 adjusts the luminance of the plurality of pixels, the panel processor 240 may reduce the luminance of the plurality of pixels based on a predetermined luminance adjustment value.

The luminance adjustment value may include a reduction rate for a preset luminance.

The luminance adjustment value may also include a subtraction value for the preset luminance.

The panel processor 240 may detect a current amount of each pixel based on the current signal of each pixel during the reduction in the luminance of the display panel based on the luminance reduction rate, may compare a maximum current amount among the detected current amount of each pixel with a target current amount so as to determine whether the maximum current amount is the target current amount, and may determine that the reduction of the luminance is completed based on the maximum current amount being determined as the target current amount.

The target current amount may be a current amount corresponding to a luminance (L=A*B %) obtained by the preset luminance (A) and the determined luminance reduction rate (B %).

The preset luminance may be the highest luminance among the luminance for preventing afterimages.

Information on luminance for each current amount may be obtained through testing and stored in a table.

The panel processor 240 may detect a temperature of each pixel based on the current signal of each pixel during the reduction in the luminance of the display panel based on the luminance reduction rate, may compare a highest temperature among the detected temperature of each pixel with a set temperature so as to determine whether the highest temperature is the set temperature, and may determine that the reduction of the luminance is completed based on the highest temperature being determined as the set temperature.

The pixel having the highest temperature may be a pixel where afterimages may occur.

The set temperature may be a temperature corresponding to a luminance obtained by the preset luminance and the determined luminance reduction rate.

Information on temperature for each luminance may be obtained through testing and stored in a table.

The panel processor 240 may detect a luminance of each pixel based on the current signal of each pixel during the reduction in the luminance of the display panel based on the luminance reduction rate, may compare a highest luminance among the detected luminance of each pixel with a target luminance so as to determine whether the highest luminance is the target luminance, and may determine that the reduction of the luminance is completed based on the highest luminance being determined as the target luminance.

The target luminance may be a luminance obtained by the preset luminance and the determined luminance reduction rate.

Information on luminance for each current may be obtained through testing and stored in a table.

The panel processor 240 may determine a reference temperature based on at least one of the panel protection menu, the afterimage index, the cumulative viewing time, and the external temperature, and may determine a luminance adjustment value for adjusting the luminance. The luminance adjustment value may include a reduction rate for the preset luminance.

The panel protection menu may include the logo brightness menu and the pixel shift menu.

The panel processor 240 may include a first processor 241 and a second processor 242.

The panel processor 240 may perform the above-described operation using data stored in the memory 250.

The panel processor 240 may include hardware such as a CPU or memory, and software such as a control program. For example, the panel processor 240 may include at least one memory provided to store data in the type of an algorithm and program for controlling the operations of components within the display apparatus and one or more processor chips configured to perform the aforementioned operations using the data stored in the at least one memory, or may include one or more processing cores.

The panel processor 240 may include a separate Neural Network Processing Unit (NPU) that performs the operation of the artificial intelligence model, and may include a graphics-only processor (GPU).

The memory 250 may store the afterimage index and the cumulative viewing time, and may store a deterioration index.

The memory 250 may store a preset reference afterimage index.

The memory 250 may store a reference temperature and a luminance adjustment value corresponding to the panel protection menu, and may store the reference temperature and the luminance adjustment value in a table form.

The luminance adjustment value may include a reduction rate for the preset luminance.

As illustrated in FIG. 8, the memory 250 may store a first reference temperature and a first luminance reduction rate corresponding to the logo brightness off, a second reference temperature and a second luminance reduction rate corresponding to the first logo brightness, and a third reference temperature and a third luminance reduction rate corresponding to the second logo brightness.

The first reference temperature, the second reference temperature and the third reference temperature may be the same.

The first reference temperature may be higher than the second reference temperature, and the second reference temperature may be higher than the third reference temperature.

The first luminance reduction rate may be lower than the second luminance reduction rate. The second luminance reduction rate may be lower than the third luminance reduction rate.

The memory 250 may store the reference temperature and luminance reduction rate corresponding to the pixel shift on and the pixel shift off, respectively, in a table.

As illustrated in FIG. 9, the memory 250 may store a fourth reference temperature and a fourth luminance reduction rate corresponding to the pixel shift on, and a fifth reference temperature and a fifth luminance reduction rate corresponding to the pixel shift off.

The fourth reference temperature may be higher than the fifth reference temperature.

The fourth luminance reduction rate may be lower than the fifth luminance reduction rate.

The memory 250 may store a reference temperature and a luminance reduction rate corresponding to the cumulative viewing time, which may be stored in a table. The luminance adjustment value may include the luminance reduction rate.

The cumulative viewing time may have an inverse relationship with the reference temperature and may have a direct relationship with the luminance adjustment value. For example, as the cumulative viewing time increases, the reference temperature may decrease and the luminance reduction rate may increase.

As illustrated in FIG. 10, the memory 250 may store a sixth reference temperature and a sixth luminance reduction rate corresponding to a first cumulative viewing time, a seventh reference temperature and a seventh luminance reduction rate corresponding to a second cumulative viewing time, an eighth reference temperature and an eighth luminance reduction rate corresponding to a third cumulative viewing time, and a ninth reference temperature and a ninth luminance reduction rate corresponding to a fourth cumulative viewing time.

The first cumulative viewing time may be shorter than the second cumulative viewing time, the second cumulative viewing time may be shorter than the third cumulative viewing time, and the third cumulative viewing time may be shorter than the fourth cumulative viewing time.

At least two of the sixth, seventh, eighth and ninth reference temperatures may be the same, and the rest may be different.

The sixth, seventh, eighth and ninth reference temperatures may all be different.

The sixth reference temperature may be higher than the seventh reference temperature, the seventh reference temperature may be higher than the eighth reference temperature, and the eighth reference temperature may be higher than the ninth reference temperature.

The sixth luminance reduction rate may be lower than the seventh luminance reduction rate. The seventh luminance reduction rate may be lower than the eighth luminance reduction rate. The eighth luminance reduction rate may be lower than the ninth luminance reduction rate.

The memory 250 may store a reference temperature and a luminance reduction rate corresponding to the afterimage index.

The afterimage index may have an inverse relationship with the reference temperature and may have a direct relationship with the luminance adjustment value. For example, as the afterimage index increases, the reference temperature may decrease and the luminance reduction rate may increase.

The memory 250 may store a tenth reference temperature and a tenth luminance reduction rate corresponding to a first afterimage index, an eleventh reference temperature and an eleventh luminance reduction rate corresponding to a second afterimage index, a twelfth reference temperature and a twelfth luminance reduction rate corresponding to a third afterimage index, and a thirteenth reference temperature and a thirteenth luminance reduction rate corresponding to a fourth afterimage index.

The first afterimage index may be lower than the second afterimage index, the second afterimage index may be lower than the third afterimage index, and the third afterimage index may be lower than the fourth afterimage index.

At least two of the tenth, eleventh, twelfth, and thirteenth reference temperatures may be the same, and the rest may be different.

The tenth, eleventh, twelfth, and thirteenth reference temperatures may all be different.

The tenth reference temperature may be higher than the eleventh reference temperature, the eleventh reference temperature may be higher than the twelfth reference temperature, and the twelfth reference temperature may be higher than the thirteenth reference temperature.

The tenth luminance reduction rate may be lower than the eleventh luminance reduction rate. The eleventh luminance reduction rate may be lower than the twelfth luminance reduction rate. The twelfth luminance reduction rate may be lower than the thirteenth luminance reduction rate.

The memory 250 may store a temperature offset value of the determined reference temperature corresponding to an external temperature. The memory 250 may store a luminance offset value of the determined luminance reduction rate corresponding to an external temperature.

The memory 250 may store data for an algorithm for controlling the operation of components within the display apparatus or a program that reproduces the algorithm.

The memory 250 and the panel processor 240 may be implemented as separate chips. Alternatively, the memory 250 and the panel processor 240 may be implemented as a single chip.

The memory 250 may be implemented as at least one of a non-volatile memory device such as a cache, a Read Only Memory (ROM), a Programmable ROM (PROM), an Erasable Programmable ROM (EPROM), an Electrically Erasable Programmable ROM (EEPROM), and a flash memory, a volatile memory device such as a Random Access Memory (RAM), or a storage medium such as a hard disk drive (HDD) or a CD-ROM, but is not limited thereto.

Hereinafter with reference to FIG. 5, a specific control configuration of the panel processor 240 will be described by being divided into a control configuration performed by the first processor 241 and a control configuration performed by the second processor 242.

The first processor 241 may be an application processor (AP).

The first processor 241 may receive an image signal from an external device and transmit the received image signal to the second processor 242.

The first processor 241 may process the received image signal and transmit the user input received through the input interface 210 to the second processor 242, and may also transmit information on the external temperature received through the temperature sensor 230 to the second processor 242.

The user input may include configuration information for the panel protection menu.

The panel protection menu may include the logo brightness menu and the pixel shift menu.

For example, the logo brightness menu may include the log brightness off, the first log brightness, and the second log brightness. Stages of the logo brightness menu are not limited to three stages.

The pixel shift menu may include the pixel shift on and the pixel shift off.

The external temperature may include a temperature surrounding the display apparatus.

The first processor 241 may encode image data corresponding to an image signal received from an external device, and transmit an image signal corresponding to the encoded image data to the second processor 242.

The first processor 241 may count the cumulative viewing time and store information on the counted cumulative viewing time.

The first processor 241 may accumulate and store the luminance and current amount of each pixel, obtain an afterimage index based on the accumulated and stored luminance and current amount of each pixel, and store information on the obtained afterimage index.

The first processor 241 may accumulate and store the luminance and temperature of each pixel, and may also obtain an afterimage index based on the accumulated and stored luminance and temperature of each pixel.

The first processor 241 may also obtain an afterimage index of each pixel.

The first processor 241 may obtain a degradation index based on the accumulated and stored luminance of each pixel, the accumulated and stored current amount of each pixel, and the cumulative viewing time. In other words, the first processor 241 may also obtain a degradation index of the display panel based on the afterimage index of each pixel.

The first processor 241 may also obtain a degradation index of the display panel based on any one of an average value of the afterimage index of each pixel, a maximum value of the afterimage index of each pixel, a median value of the afterimage index of each pixel, and a minimum value of the afterimage index of each pixel.

The first processor 241 may transmit setting information of the panel protection menu, the external temperature, the afterimage index, and the cumulative viewing time to the second processor 242 so as to determine the reference temperature and the luminance reduction rate.

The first processor 241 may also transmit a degradation index to the second processor 242 to determine the reference temperature and the luminance reduction rate.

The first processor 241 may determine a reference temperature based on at least one of the setting information of the panel protection menu, the afterimage index, and the cumulative viewing time, and may also determine a luminance reduction rate.

The first processor 241 may determine a reference temperature based on the external temperature and may also determine a luminance reduction rate.

The first processor may also adjust a reference temperature determined based on the external temperature. The first processor may lower the determined reference temperature as the external temperature increases, and raise the reference temperature as the external temperature decreases.

The first processor 241 may determine a reference temperature based on the deterioration index and may also determine a luminance reduction rate.

The second processor 242 may receive user input from the first processor 241.

The user input may include setting information for the panel protection menu.

The panel protection menu may include the logo brightness menu and the pixel shift menu.

The second processor 242 may receive a cumulative viewing time and an afterimage index from the first processor 241, and may receive information on an external temperature from the first processor 241.

The second processor 242 may also receive a degradation index from the first processor 241.

The second processor 242 may receive an image signal from the first processor 241, convert the received image signal into a control signal, and transmit the control signal to the display driver 160.

The second processor 242 may generate a data signal based on the received image signal and transmit the generated data signal to the first driver 161, and may generate a scan signal based on the received image signal and transmit the generated scan signal to the second driver 162.

The second processor 242 may detect a current of each pixel based on the operation signal received from the first driver 161, and detect a temperature of each pixel based on the detected current of each pixel.

The second processor 242 may include a current detector configured to detect a current of each pixel of the display panel 10c based on an operation signal of each of the plurality of pixels, and the temperature detector 240a for detecting a temperature of each pixel based on the detected current of each pixel.

The second processor 242 may include the temperature detector 240a configured to detect a temperature of each pixel of the display panel 10c based on the operation signal of each of the plurality of pixels.

The temperature detector 240a may also be provided separately from the second processor 242. In this case, the temperature detector 240a may detect the current of each pixel of the display panel 10c based on the operation signal of each of the plurality of pixels, detect the temperature of each pixel corresponding to the detected current of each pixel, and transmit information on the detected temperature of each pixel to the second processor 242.

Temperatures corresponding to the currents may be pre-stored in a table.

The operation signal may include a data signal. The operation signal may include a current signal. The operation signal may also include a voltage signal.

The second processor 242 may receive a data signal of each pixel from the first driver 161 during a blank period, and detect a current signal of each pixel based on the received data signal of each pixel. The second processor 242 may detect a temperature of each pixel based on the detected current of each pixel.

The current signal may include a current amount.

The blank period may be a period between two frames where a black screen is displayed.

The second processor 242 may determine a reference temperature based on at least one of the setting information of the panel protection menu, the afterimage index, and the cumulative viewing time, and determine a luminance reduction rate.

The second processor 242 may determine a reference temperature based on the external temperature and may also determine a luminance reduction rate.

The second processor 242 may also adjust the reference temperature determined based on the external temperature. The second processor 242 may lower the determined reference temperature as the external temperature increases, and may raise the reference temperature as the external temperature decreases.

The second processor 242 may determine a reference temperature based on the deterioration index, and may also determine a luminance reduction rate.

The second processor 242 may adjust a luminance of some or all pixels based on the detected temperature of each pixel, the determined reference temperature, and the determined luminance reduction rate.

The second processor 242 may obtain a highest temperature among the detected temperature of each pixel and adjust the luminance of the plurality of pixels of the display panel based on the obtained highest temperature being greater than or equal to the reference temperature.

The second processor 242 may obtain a highest temperature among the detected temperature of each pixel, and obtain at least one pixel having a temperature greater than or equal to the reference temperature among the plurality of pixels based on the obtained highest temperature being greater than or equal to the reference temperature. Accordingly, the second processor 242 may adjust a luminance of the obtained at least one pixel.

As illustrated in FIG. 11, based on temperatures of pixels 11, which correspond to a K Broadcasting logo among the temperatures of the pixels, being the highest temperature, the second processor 242 may adjust a luminance of the pixels 11 corresponding to the K Broadcasting logo. The second processor 242 may obtain a reference temperature and a luminance reduction rate based on the logo brightness menu, and reduce the luminance of the pixels 11 corresponding to the K Broadcasting logo at the determined luminance reduction rate based on the highest temperature being greater than or equal to the obtained reference temperature. In this case, the second processor 242 may maintain the luminance of the remaining pixels 12 and 13.

Based on a fact that the temperatures of the pixels 11 corresponding to the K Broadcasting logo and temperatures of pixels 12 corresponding to a NEWS banner among the temperatures of the pixels are the highest temperature, and a fact that the highest temperature is greater than or equal to the determined reference temperature, the second processor 242 may reduce the luminance of the pixels 11 corresponding to the K Broadcasting logo and the luminance of the pixels 12 corresponding to the NEWS banner at the determined luminance reduction rate. In this case, the second processor 242 may maintain the luminance of the remaining pixels 13.

Based on a fact that the temperatures of the pixels 11 corresponding to the K Broadcasting logo and the temperatures of pixels 12 corresponding to the NEWS banner among the temperatures of the pixels are the highest temperature, and a fact that the highest temperature is greater than or equal to the determined reference temperature, the second processor 242 may reduce the luminance of the plurality of pixels 11, 12, and 13 of the display panel at the determined luminance reduction rate.

The configuration of the second processor 242 configured to determine the reference temperature and luminance reduction rate will be described in more detail.

The second processor 242 may determine a reference temperature and a luminance reduction rate based on the setting information of the logo brightness menu.

For example, the second processor 242 may determine the reference temperature as the first reference temperature and determine the luminance reduction rate as the first luminance reduction rate based on the setting information of the panel protection menu being information on the logo brightness off.

The second processor 242 may determine the reference temperature as the second reference temperature and determine the luminance reduction rate as the second luminance reduction rate based on the setting information of the panel protection menu being information on the first logo brightness.

The second processor 242 may determine the reference temperature as the third reference temperature and determine the luminance reduction rate as the third luminance reduction rate based on the setting information of the panel protection menu being information on the second logo brightness.

The first reference temperature, the second reference temperature and the third reference temperature may be the same.

At least two of the first reference temperature, the second reference temperature, and the third reference temperature may be the same, and the remaining one may be different.

The first reference temperature, the second reference temperature, and the third reference temperature may all be different. In this case, the first reference temperature may be higher than the second reference temperature, and the second reference temperature may be higher than the third reference temperature.

The first luminance reduction rate may be lower than the second luminance reduction rate. The second luminance reduction rate may be lower than the third luminance reduction rate.

The second processor 242 may determine the reference temperature and the luminance reduction rate based on the setting information of the pixel shift menu.

For example, the second processor 242 may determine the reference temperature as the fourth reference temperature and the luminance reduction rate as the fourth luminance reduction rate based on the setting information of the panel protection menu being information on the pixel shift on.

The second processor 242 may determine the reference temperature as the fifth reference temperature and the luminance reduction rate as the fifth luminance reduction rate based on the setting information of the panel protection menu being information on the pixel shift off.

The fourth reference temperature may be higher than the fifth reference temperature. The fourth luminance reduction rate may be lower than the fifth luminance reduction rate.

The second processor 242 may determine the reference temperature and the luminance reduction rate based on the received cumulative viewing time.

For example, the second processor 242 may obtain the sixth reference temperature and the sixth luminance reduction rate corresponding to the first cumulative viewing time based on the received cumulative viewing time being the first cumulative viewing time. Accordingly, the second processor 242 may determine the reference temperature as the obtained sixth reference temperature, and determine the luminance reduction rate as the obtained sixth luminance reduction rate.

The second processor 242 may obtain the seventh reference temperature and the seventh luminance reduction rate corresponding to the second cumulative viewing time based on the cumulative viewing time being the second cumulative viewing time. Accordingly, the second processor 242 may determine the reference temperature as the obtained seventh reference temperature, and determine the luminance reduction rate as the obtained seventh luminance reduction rate.

The second processor 242 may obtain the eighth reference temperature and the eighth luminance reduction rate corresponding to the third cumulative viewing time based on the cumulative viewing time being the third cumulative viewing time. Accordingly, the second processor 242 may determine the reference temperature as the obtained eighth reference temperature, and determine the luminance reduction rate as the obtained eighth luminance reduction rate.

The second processor 242 may obtain the ninth reference temperature and the ninth luminance reduction rate corresponding to the fourth cumulative viewing time based on the cumulative viewing time being the fourth cumulative viewing time. Accordingly, the second processor 242 may determine the reference temperature as the obtained ninth reference temperature, and determine the luminance reduction rate as the obtained ninth luminance reduction rate.

The first cumulative viewing time may be shorter than the second cumulative viewing time, the second cumulative viewing time may be shorter than the third cumulative viewing time, and the third cumulative viewing time may be shorter than the fourth cumulative viewing time.

At least two of the sixth, seventh, eighth and ninth reference temperatures may be the same, and the rest may be different.

The sixth, seventh, eighth and ninth reference temperatures may all be different. The sixth reference temperature may be higher than the seventh reference temperature, the seventh reference temperature may be higher than the eighth reference temperature, and the eighth reference temperature may be higher than the ninth reference temperature.

The sixth luminance reduction rate may be lower than the seventh luminance reduction rate. The seventh luminance reduction rate may be lower than the eighth luminance reduction rate. The eighth luminance reduction rate may be lower than the ninth luminance reduction rate.

The second processor 242 may also determine the reference temperature and the luminance reduction rate based on the received afterimage index.

For example, the second processor 242 may obtain the tenth reference temperature and the tenth luminance reduction rate corresponding to the first afterimage index based on the received afterimage index being the first afterimage index. Accordingly, the second processor 242 may determine the reference temperature as the tenth reference temperature, and determine the luminance reduction rate as the tenth luminance reduction rate.

The second processor 242 may obtain the eleventh reference temperature and the eleventh luminance reduction rate corresponding to the second afterimage index based on the received afterimage index being the second afterimage index. Accordingly, the second processor 242 may determine the reference temperature as the eleventh reference temperature, and determine the luminance reduction rate as the eleventh luminance reduction rate.

The second processor 242 may obtain the twelfth reference temperature and the twelfth luminance reduction rate corresponding to the third afterimage index based on the received afterimage index being the third afterimage index. Accordingly, the second processor 242 may determine the reference temperature as the twelfth reference temperature, and determine the luminance reduction rate as the twelfth luminance reduction rate.

The second processor 242 may obtain the thirteenth reference temperature and the thirteenth luminance reduction rate corresponding to the fourth afterimage index based on the received afterimage index being the fourth afterimage index. Accordingly, the second processor 242 may determine the reference temperature as the thirteenth reference temperature, and determine the luminance reduction rate as the thirteenth luminance reduction rate.

The second processor 242 may also determine the reference temperature and luminance reduction rate based on the received degradation index.

The second processor 242 may obtain a temperature offset value corresponding to the received external temperature based on the received external temperature, and adjust the determined reference temperature based on the obtained temperature offset value.

The second processor 242 may also obtain a luminance offset value corresponding to the received external temperature based on the received external temperature, and adjust the determined luminance reduction rate based on the obtained luminance offset value.

When the afterimage index of each pixel is received, the second processor 242 may determine necessity of luminance adjustment for preventing afterimage of each pixel based on the received afterimage index of each pixel. Based on determining that the luminance adjustment is unnecessary for at least one pixel, the second processor 242 may omit the luminance adjustment for the at least one pixel.

Based on the afterimage index of at least one pixel being greater than or equal to a preset reference afterimage index, the second processor 242 may omit the luminance adjustment of the at least one pixel.

As illustrated in FIG. 12, based on an afterimage index of pixels 14, which correspond to a S logo, being greater than or equal to the preset reference afterimage index, the processor 242 may omit the luminance adjustment of the pixels 14 corresponding to the S logo.

The higher the afterimage index, the higher the possibility of the occurrence of the afterimage.

Based on an afterimage index of the remaining pixels 15 being less than the preset reference afterimage index, the second processor 242 may determine a reference temperature and a luminance reduction rate based on the afterimage index of the remaining pixels 15. The second processor 242 may obtain a highest temperature among temperatures of the remaining pixels. The second processor 242 may control a reduction in luminance of the display panel based on the obtained highest temperature, the determined reference temperature, and the determined luminance reduction rate.

The second processor 242 may also omit luminance adjustment for at least one pixel based on the degradation index.

The second processor 242 may estimate a luminance adjustable time of each pixel for preventing afterimage for each pixel based on the afterimage index of each pixel. The second processor 242 may control the luminance adjustment of each pixel for preventing afterimage based on the luminance adjustable time of each pixel.

Further, the second processor 242 may estimate the luminance adjustable time for preventing afterimages on the display panel based on the deterioration index. The second processor 242 may control the luminance adjustment of the display panel for preventing afterimages based on the luminance adjustable time of the display panel.

The second processor 242 may obtain a reference temperature corresponding to the panel protection menu, a reference temperature corresponding to the afterimage index, and a reference temperature corresponding to the cumulative viewing time, and determine a lowest reference temperature among the obtained reference temperatures as the reference temperature for preventing afterimages. Accordingly, the second processor 242 may determine a luminance reduction rate corresponding to the obtained reference temperature as the luminance reduction rate for preventing afterimages.

For example, based on the setting information of the panel protection menu being information on the logo brightness off and pixel shift off, the second processor 242 may obtain the first reference temperature corresponding to information on the logo brightness off and the pixel shift off, and obtain the fifth reference temperature corresponding to information on the pixel shift off. The second processor 242 may compare the first reference temperature with the fifth reference temperature, and based on the first reference temperature being lower than the fifth reference temperature, may determine the luminance reduction rate as the fifth luminance reduction rate.

As another example, the second processor 242 may obtain the third reference temperature corresponding to the information on the second logo brightness based on the setting information of the panel protection menu being information on the second logo brightness, and the second processor 242 may obtain the ninth reference temperature corresponding to the information on the fourth cumulative viewing time based on the received cumulative viewing time being the fourth cumulative viewing time. The second processor 242 may compare the third reference temperature with the ninth reference temperature, and based on the third reference temperature being lower than the ninth reference temperature, may determine the reference temperature for preventing afterimages as the ninth reference temperature and determine the luminance reduction rate for preventing afterimages as the ninth luminance reduction rate.

The second processor 242 may compare the luminance reduction rates corresponding to the two or more reference temperatures based on the two or more obtained reference temperatures being all the same, obtain a largest luminance reduction rate among the luminance reduction rates, and determine the obtained luminance reduction rate as the luminance reduction rate for preventing afterimages.

The specific configuration of the first processor 241 and the second processor 242 will be described with an example.

The first processor 241 may include a central processing unit (CPU) configured to control the overall operation of the first processor 241, a graphic processing unit (GPU) for image processing, a display controller configured to generate image data and control the display driver 160, an encoder configured to compress image data, and a communication interface configured to receive an image signal from an external device and transmit an image signal and a control command corresponding to the data compressed in the encoder.

The central processing unit may also perform image processing functions. In this case, the graphics processing unit may be omitted.

The control command may include user input received via the input interface 210.

The central processing unit may perform computational processing of data to be output to the display apparatus 1 in response to user input. The central processing unit may transmit the computed data to the display controller.

The display controller may generate image data to be transmitted to the second processor 242 based on data received from an external device.

The display controller may control an output speed of image data.

The display controller may also transmit an image signal corresponding to the image data to the second processor 242 without a compression process for the image data.

The communication interface may transmit the image signal corresponding to the image data encoded by the encoder to the second processor 242.

The central processing unit, the graphic processing unit, the display controller, the encoder, and the communication interface of the first processor 241 may be implemented as a system on chip (SOC).

The second processor 242 may include a communication interface, a graphics memory, a decoder, an image processing portion, a timing controller, and a power management portion.

The communication interface may receive an image signal from the first processor 241 and receive information on the external temperature and setting information of the panel protection menu.

The communication interface may receive the cumulative viewing time, afterimage index, and deterioration index from the first processor 241.

The graphics memory temporarily stores image data corresponding to the received image signal, and transmits the stored image data to the display driver.

The decoder may perform decoding of image data stored in the graphics memory.

The decoder may decode image data corresponding to an image signal received via the communication interface. When an uncompressed image signal is received from the first processor 241, decoding in the second processor may be omitted.

The image processing portion may process an image signal corresponding to decoded image data or a received image signal, and transmit the signal-processed image data to the timing controller.

The timing controller may convert image data received from the image processing portion into a control signal required by the display driver 160.

The timing controller may control the overall operation performed in the second processor 242. The timing controller may detect the temperature of each pixel of the display panel, determine the reference temperature and the luminance reduction rate, and adjust the luminance of the display panel based on the detected temperature of each pixel, the reference temperature, and the luminance reduction rate.

The timing controller may supply a synchronizing signal or a clock signal to the first and second drivers 161 and 162.

The power management portion generates a voltage for driving the display panel 10c and supplies the generated voltage to the first driver 161 and the second driver 162.

The power management portion may also supply the power required for the operation of each component of the second processor 242.

As illustrated in FIG. 13, it can be seen that the brightness of the pixel is reduced by adjusting the luminance of the display panel based on the detected temperature of each pixel, the reference temperature, and the luminance reduction rate.

As illustrated in FIG. 14, it can be seen that by reducing the luminance of the display panel, the temperature of the pixels is also lowered.

As mentioned above, it is possible to prevent the occurrence of the afterimage by adjusting the luminance of the display panel based on the detected temperature of each pixel, the reference temperature, and the luminance reduction rate, and by lowering the temperature of the pixel through the luminance adjustment.

At least one component may be added or deleted to correspond to the performance of the components of the display apparatus illustrated in FIGS. 4 and 5. Furthermore, it will be readily apparent to those skilled in the art that the relative positions of the components may be changed to correspond to the performance or structure of the system.

Each component illustrated in FIGS. 4 and 5 refers to software and/or hardware components such as Field Programmable Gate Array (FPGA) and Application Specific Integrated Circuit (ASIC).

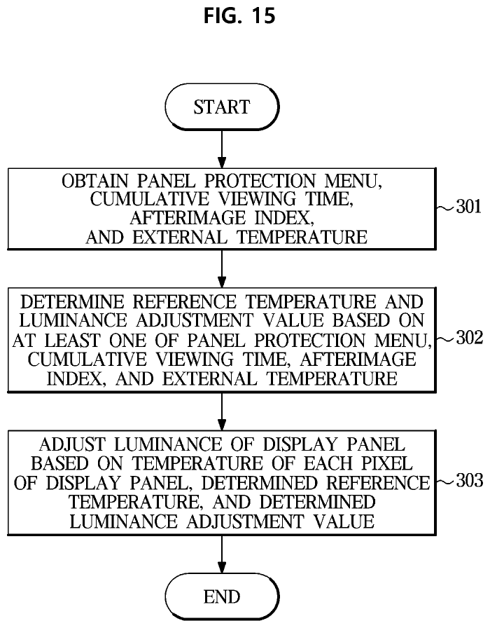

FIG. 15 is a control flowchart for determining a reference temperature and luminance adjustment value of the display apparatus according to one or more embodiments.

The display apparatus obtains the panel protection menu, the cumulative viewing time, the afterimage index, and the external temperature (301). This will be described in more detail.

The panel protection menu may include the logo brightness menu for setting whether to set the logo brightness, and the pixel shift menu for setting whether to perform pixel shift.

Information on the logo brightness off may be default information.

Information on the pixel shift on may be default information.

The display apparatus may determine whether to change the setting information of the panel protection menu based on user input received through the input interface 210, and may obtain the setting information of the panel protection menu based on whether to change the setting information of the panel protection menu.

The display apparatus may check whether the setting information of the panel protection menu is information on the logo brightness off, information on the first logo brightness, or information on the second logo brightness, and obtain the checked information as the setting information of the panel protection menu.

The display apparatus may check whether the setting information of the panel protection menu is information on the pixel shift off or information on the pixel shift on, and obtain the checked information as the setting information of the panel protection menu.

The display apparatus may obtain a viewing time from a point of time, on which a display apparatus's on command is received, to a point of time, on which a display apparatus's off command is received, and store the obtained viewing time. In other words, the display apparatus may obtain a cumulative viewing time by adding up the stored viewing times.

The display apparatus may store a luminance of each pixel and a temperature of each pixel while the display apparatus is turned on, and obtain an afterimage index based on the currently stored luminance of each pixel and temperature of each pixel and the previously stored luminance of each pixel and temperature of each pixel.

The display apparatus may obtain temperature information received from the temperature sensor 230 as an external temperature.

The display apparatus may determine the reference temperature and luminance adjustment value based on at least one of the obtained panel protection menu, cumulative viewing time, afterimage index, and external temperature (302). This will be described with an example.

The display apparatus may determine the reference temperature as the first reference temperature and the luminance reduction rate as the first luminance reduction rate based on the setting information of the panel protection menu being the information on the logo brightness off.

The display apparatus may determine the reference temperature as the second reference temperature and the luminance reduction rate as the second luminance reduction rate based on the setting information of the panel protection menu being information on the first logo brightness.

The display apparatus may determine the reference temperature as the third reference temperature and the luminance reduction rate as the third luminance reduction rate based on the setting information of the panel protection menu being information on the second logo brightness.

The display apparatus may determine the reference temperature as the fourth reference temperature and the luminance reduction rate as the fourth luminance reduction rate based on the setting information of the panel protection menu being information on the pixel shift on.

The display apparatus may determine the reference temperature as the fifth reference temperature and the luminance reduction rate as the fifth luminance reduction rate based on the setting information of the panel protection menu being information on the pixel shift off.

The display apparatus may obtain the sixth reference temperature and the sixth luminance reduction rate corresponding to the first cumulative viewing time based on the received cumulative viewing time being the first cumulative viewing time. The display apparatus may determine the reference temperature as the obtained sixth reference temperature, and determine the luminance reduction rate as the obtained sixth luminance reduction rate.

The display apparatus may obtain the seventh reference temperature and the seventh luminance reduction rate corresponding to the second cumulative viewing time based on the cumulative viewing time being the second cumulative viewing time. The display apparatus may determine the reference temperature as the obtained seventh reference temperature, and determine the luminance reduction rate as the obtained seventh luminance reduction rate.

The display apparatus may obtain the eighth reference temperature and the eighth luminance reduction rate corresponding to the third cumulative viewing time based on the cumulative viewing time being the third cumulative viewing time. The display apparatus may determine the reference temperature as the obtained eighth reference temperature, and determine the luminance reduction rate as the obtained eighth luminance reduction rate.

The display apparatus may obtain the ninth reference temperature and the ninth luminance reduction rate corresponding to the fourth cumulative viewing time based on the cumulative viewing time being the fourth cumulative viewing time. The display apparatus may determine the reference temperature as the obtained ninth reference temperature, and determine the luminance reduction rate as the obtained ninth luminance reduction rate.

The display apparatus may obtain the tenth reference temperature and the tenth luminance reduction rate corresponding to the first afterimage index based on the received afterimage index being the first afterimage index. The display apparatus may determine the reference temperature as the tenth reference temperature, and determine the luminance reduction rate as the tenth luminance reduction rate.

The display apparatus may obtain the eleventh reference temperature and the eleventh luminance reduction rate corresponding to the second afterimage index based on the received afterimage index being the second afterimage index. The display apparatus may determine the reference temperature as the eleventh reference temperature, and determine the luminance reduction rate as the eleventh luminance reduction rate.

The display apparatus may obtain the twelfth reference temperature and the twelfth luminance reduction rate corresponding to the third afterimage index based on the received afterimage index being the third afterimage index. The display apparatus may determine the reference temperature as the twelfth reference temperature, and determine the luminance reduction rate as the twelfth luminance reduction rate.

The display apparatus may obtain the thirteenth reference temperature and the thirteenth luminance reduction rate corresponding to the fourth afterimage index based on the received afterimage index being the fourth afterimage index. The display apparatus may determine the reference temperature as the thirteenth reference temperature, and determine the luminance reduction rate as the thirteenth luminance reduction rate.

The display apparatus may obtain the temperature offset value corresponding to the received external temperature based on the received external temperature, and adjust the determined reference temperature based on the obtained temperature offset value.

The display apparatus may adjust the luminance of the display panel based on the temperature of each pixel of the display panel, the determined reference temperature, and the determined luminance adjustment value (303).

The display apparatus may compare the temperature of each pixel of the display panel with the determined reference temperature, and adjust the luminance of the display panel based on the determined luminance adjustment value based on the comparison result (303).

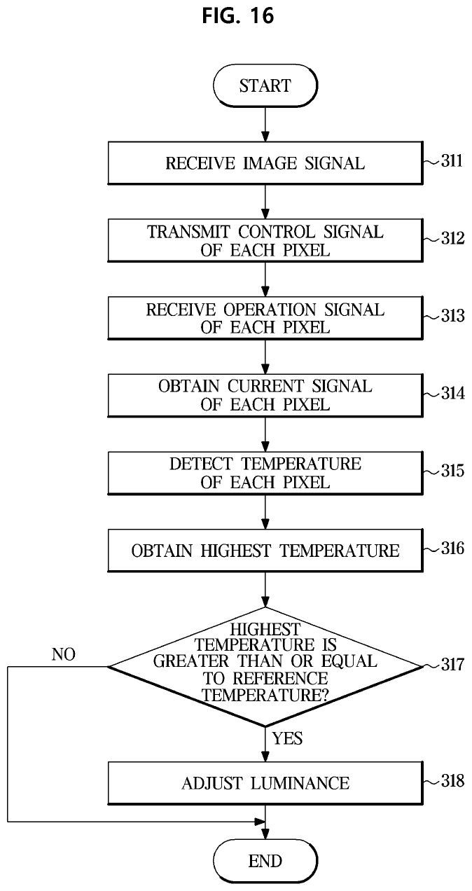

FIG. 16 is a control flowchart for adjusting the luminance of the display apparatus according to one or more embodiments.

The display apparatus may receive an image signal from an external device (311).

The display apparatus may generate a control signal of each of a plurality of pixels based on the received image signal, and transmit the control signal of each of the plurality of pixels to the display driver 160 (312).

The generating of the control signal of each of the plurality of pixels may include generating a data signal of each of the plurality of pixels and a scan signal of each of the plurality of pixels.

The transmitting of the control signal of each of the plurality of pixels to the display driver 160 may include transmitting the data signal of each of the plurality of pixels to the first driver 161 and transmitting the scan signal of each of the plurality of pixels to the second driver 162.

The display apparatus may receive an operation signal of each of the plurality of pixels from the first driver 161 (313) and detect a current signal of each pixel based on the received operation signal of each pixel (314). The operation signal of each of the plurality of pixels may include a data signal of each of the plurality of pixels.

The display apparatus may receive the data signal of each pixel from the first driver 161 during the blank period, and detect the current signal of each pixel based on the received data signal of each pixel.

The current signal corresponding to the data signal may be pre-stored in a table.

The blank period may be a period between two frames where a black screen is displayed.

The display apparatus may detect the temperature of each pixel of the display panel 10c based on the current signal of each of the plurality of pixels (315).

Information on the temperature corresponding to the current signal may be pre-stored in a table as information obtained through testing.

The display apparatus adjusts the luminance of the display panel based on the detected temperature of each pixel and the determined reference temperature.

Particularly, the display apparatus obtains the highest temperature among the detected temperature of each pixel (316), and compares the obtained highest temperature with the reference temperature to determine whether the obtained highest temperature is greater than or equal to the reference temperature (317).

The display apparatus may adjust the luminance of the plurality of pixels of the display panel based on the obtained highest temperature being greater than or equal to the determined reference temperature (318).

The adjusting of the luminance of the plurality of pixels of the display panel may include adjusting the luminance of the plurality of pixels based on the determined luminance adjustment value. The luminance adjustment value may include a luminance reduction rate relative to a preset luminance.

The adjusting of the luminance of the plurality of pixels of the display panel may be adjusting luminance of all of the plurality of pixels based on the obtained highest temperature being greater than or equal to the reference temperature.

The adjusting of the luminance of the plurality of pixels of the display panel may obtain at least one pixel, which has a temperature greater than or equal to the reference temperature, among the plurality of pixels based on the obtained highest temperature being greater than or equal to the reference temperature, and may adjust a luminance of the obtained at least one pixel.

The adjusting of the luminance of the plurality of pixels of the display panel may include reducing the luminance of the plurality of pixels based on the determined luminance reduction rate.

The display apparatus may detect a current amount of each pixel based on the current signal of each pixel during the reduction in the luminance of the display panel based on the luminance reduction rate, may compare a maximum current amount among the detected current amount of each pixel with a target current amount so as to determine whether the maximum current amount is the target current amount, and may determine that the reduction of the luminance is completed based on the maximum current amount being determined as the target current amount.

The target current amount may be a current amount corresponding to a luminance (L=A*B %) obtained by the preset luminance (A) and the determined luminance reduction rate (B %).

The preset luminance may be the highest luminance among the luminance to prevent afterimages.

Information on luminance of each current amount may be obtained through testing and stored in a table.

The display apparatus may detect a temperature of each pixel based on the current signal of each pixel during the reduction in the luminance of the display panel based on the luminance reduction rate, may compare a highest temperature among the detected temperature of each pixel with a set temperature so as to determine whether the highest temperature is the set temperature, and may determine that the reduction of the luminance is completed based on the highest temperature being determined as the set temperature.

The set temperature may be a temperature corresponding to a luminance obtained by the preset luminance and the determined luminance reduction rate.

Information on temperature of each luminance may be obtained through testing and stored in a table.

The display apparatus may detect a luminance of each pixel based on the current signal of each pixel during the reduction in the luminance of the display panel based on the luminance reduction rate, may compare a highest luminance among the detected luminance of each pixel with a target luminance so as to determine whether the highest luminance is the target luminance, and may determine that the reduction of the luminance is completed based on the highest luminance being determined as the target luminance.

The target luminance may be a luminance obtained by the preset luminance and the determined luminance reduction rate.

Information on luminance of each current may be obtained through testing and stored in a table.

The disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

According to one or more embodiments, it may be possible to prevent occurrence of afterimage by obtaining a temperature of each of a plurality of pixels of a display panel and by adjusting a luminance of the display panel based on the obtained temperature of each of the pixels. That is, it may be possible to prevent occurrence of afterimage in areas of the display panel where the same image, such as a broadcaster's logo, a current time, or a subtitle, is continuously displayed.

According to one or more embodiments, it may be possible to delay an afterimage occurrence time of a display panel by determining a reference temperature and a luminance adjustment value based on at least one of a panel protection menu, an external temperature, a cumulative viewing time, and an afterimage index. Accordingly, it is possible to extend lifespan of a display apparatus and further provide a user with a best picture quality without afterimages.

According to one or more embodiments, it may be possible to improve a marketability of a display apparatus, further increase a user satisfaction, enhance a user reliability, and secure a product competitiveness.

While the present disclosure has been particularly described with reference to exemplary embodiments, it should be understood by those of skilled in the art that various changes in form and details may be made without departing from the spirit and scope of the present disclosure.

What is claimed is:

1. A display apparatus comprising:
a display panel comprising a plurality of pixels;
a temperature detector configured to detect a temperature of each pixel of the plurality of pixels; and
at least one panel processor configured to adjust a luminance of the display panel based on the temperature of each pixel of the plurality of pixels, a reference temperature, and a luminance adjustment value,
wherein the at least one panel processor is configured to determine the reference temperature and the luminance adjustment value based on at least one of a panel protection menu, an afterimage index, and a cumulative viewing time.

2. The display apparatus of claim 1, wherein the panel protection menu comprises: a logo brightness menu for setting a brightness of a logo, and a pixel shift menu for setting whether to perform pixel shift,
the at least one panel processor is configured to determine at least one of the reference temperature and the luminance adjustment value based on brightness information of the logo set by the logo brightness menu; and
the at least one panel processor is configured to determine at least one of the reference temperature and the luminance adjustment value based on whether to perform the pixel shift set by the pixel shift menu.

3. The display apparatus of claim 1, further comprising:
a temperature sensor configured to detect an external temperature outside the display panel,
wherein the at least one panel processor is further configured to determine the reference temperature and the luminance adjustment value based on the external temperature.

4. The display apparatus of claim 1, wherein the reference temperature and the cumulative viewing time have an inverse relationship in which the reference temperature decreases as the cumulative viewing time increases, and
the luminance adjustment value and the cumulative viewing time have a direct relationship in which the luminance adjustment value increases as the cumulative viewing time increases.

5. The display apparatus of claim 1, wherein the reference temperature and the afterimage index have an inverse relationship in which the reference temperature decreases as the afterimage index decreases, and
the luminance adjustment value and the afterimage index have a direct relationship in which the luminance adjustment value increases as the afterimage index increases.

6. The display apparatus of claim 1, wherein the at least one panel processor is configured to:
obtain a highest temperature among the temperature of each pixel of the plurality of pixels, and
based on the highest temperature being greater than or equal to the reference temperature, adjust the luminance of each pixel of the plurality of pixels of the display panel based on the luminance adjustment value.

7. The display apparatus of claim 1, wherein the at least one panel processor is configured to:
obtain a highest temperature among the temperature of each of the plurality of pixels,
obtain at least one pixel having a temperature greater than or equal to the reference temperature among the plurality of pixels based on the highest temperature being greater than or equal to the reference temperature, and
adjust the luminance of the at least one pixel based on the luminance adjustment value.

8. The display apparatus of claim 1, further comprising:
an input interface configured to receive information on the panel protection menu and transmit the information on the panel protection menu to the at least one panel processor.

9. The display apparatus of claim 1, further comprising:
a display driver connected to the display panel,
wherein the at least one panel processor is configured to convert an image signal received from an external device into a control signal of each pixel of the plurality of pixels and transmit the control signal of each pixel of the plurality of pixels to the display driver; and
wherein the at least one panel processor is configured to detect the temperature of each pixel of the plurality of pixels based on an operation signal of the display driver.

10. The display apparatus of claim 9, wherein the at least one panel processor comprises:
at least one first processor configured to receive the image signal from the external device; and
at least one second processor configured to convert the image signal received from the at least one first processor into the control signal of each pixel of the plurality of pixels, transmit the control signal of each pixel of the plurality of pixels to the display driver, detect the temperature of each of the plurality of pixels, and adjust the luminance of the display panel, and
the at least one first processor is further configured to obtain at least one of the panel protection menu, the cumulative viewing time, and the afterimage index, and transmit the at least one of the panel protection menu, the cumulative viewing time, and the afterimage index to the at least one second processor.

11. A control method of a display apparatus, the control method comprising:
determining a reference temperature and a luminance adjustment value based on at least one of a panel protection menu, an afterimage index, and a cumulative viewing time;
detecting a temperature of each pixel of a plurality of pixels of a display panel; and
adjusting a luminance of the display panel based on the temperature of each pixel of the plurality of pixels, the reference temperature, and the luminance adjustment value.

12. The control method of the display apparatus of claim 11, wherein the determining the reference temperature and the luminance adjustment value based on the at least one of the panel protection menu, the afterimage index, and the cumulative viewing time comprises:
determining at least one of the reference temperature and the luminance adjustment value based on brightness information of a logo set by a logo brightness menu in the panel protection menu; and
determining at least one of the reference temperature and the luminance adjustment value based on whether to perform pixel shift set by a pixel shift menu in the panel protection menu.

13. The control method of the display apparatus of claim 11, further comprising:
detecting an external temperature outside the display panel; and
determining the reference temperature and the luminance adjustment value based on the external temperature.

14. The control method of the display apparatus of claim 11, wherein the reference temperature and the cumulative viewing time have an inverse relationship in which the reference temperature decreases as the cumulative viewing time increases, and
the luminance adjustment value and the cumulative viewing time have a direct relationship in which the luminance adjustment value increases as the cumulative viewing time increases.

15. The control method of the display apparatus of claim 11, wherein the reference temperature and the afterimage index have an inverse relationship in which the reference temperature decreases as the afterimage index decreases, and
the luminance adjustment value and the afterimage index have a direct relationship in which the luminance adjustment value increases as the afterimage index increases.

16. The control method of the display apparatus of claim 11, wherein the detecting the temperature of each pixel of the plurality of pixels of the display panel comprises:
obtaining an operation signal of each pixel;
detecting the temperature of each pixel of the plurality of pixels based on the operation signal of each pixel; and
obtaining a highest temperature among the temperature of each pixel of the plurality of pixels, and
adjusting the luminance of the display panel comprises:
based on the highest temperature being greater than or equal to the reference temperature, adjusting the luminance of each pixel of the plurality of pixels of the display panel based on the luminance adjustment value.
